(19) United States
(12) Patent Application Publication
(10) Pub. No.: US 2026/0131312 A1
(43) Pub. Date: May 14, 2026

(54) METHOD FOR PHOTOCATALYTIC DEGRADATION OF PLASTIC MATERIALS UNDER VISIBLE LIGHT

(71) Applicants: Centre National de la Recherche Scientifique, Paris (FR); CY CERGY PARIS UNIVERSITE, Cergy (FR); UNIVERSITE PARIS-SACLAY, Gif-sur- Yvette (FR)

(72) Inventors: Nicolas PASTERNAK, Avernes (FR); Nancy LINDER, Neuville sur Oise (FR); Florian GALLIER, Sartrouville (FR)

(21) Appl. No.: 19/120,095

(22) PCT Filed: Oct. 10, 2023
(86) PCT No.: PCT/EP2023/078054

§ 371 Date: Apr. 10, 2025

(30) Foreign Application Priority Data
Oct. 14, 2022 (FR) FR2210589

(51) Int. Cl. B01J 23/30; B01J 21/06; B01J 35/39; B01J 38/02; B09B 3/50; B09B 3/70; B09B 101/75

(52) U.S. Cl. CPC B01J 23/30; B01J 21/063; B01J 35/39; B01J 38/02; B09B 3/50; B09B 3/70; B09B 2101/75

(57) ABSTRACT

A method for producing agglomerated and activated TiO₂ or TiO₂/MₓO_{y} comprising the steps of: preparing and heating a surfactant-free aqueous solution at neutral pH or at a given acidic pH, adding to the acidic or neutral aqueous solution a titanium oxide precursor, or a mixture of a titanium oxide precursor TiO₂ and at least one other precursor of another oxide MₓO_{y}, composed of more than 80 mol % of TiO₂ and less than 20 mol % of another metal or semi-metal oxide MₓO_{y}, and stirring the acidic or neutral aqueous reaction medium; immersing a plastic material or a crushed mixture of plastic materials in the acidic or neutral aqueous reaction medium; heating the acidic or neutral aqueous reaction medium at a temperature of between 30° C. and 90° C.; photocatalytically degrading, at neutral or acidic pH, the plastic material or the mixture of plastic materials to obtain agglomerated and activated TiO₂ or TiO₂/MₓO_{y}.

The invention relates to the photocatalytic degradation of plastic materials.

### STATE OF THE ART

Photocatalysis is an oxidation method that allows the production of oxidizing species, in particular radicals, by irradiation at wavelengths corresponding to energies above the bandgap energy of certain semiconductor solids, in the presence of water and oxygen.

Photocatalysis involves a photocatalyst, i.e. a catalyst activated by light energy, with water and oxygen from the air as oxidants. The photocatalyst makes it possible to accelerate a chemical reaction, without being consumed in the end. It is generally a semiconductor belonging to oxide (TiO₂, ZnO) or sulfide (CdS, ZnS) type chalcogenides, the photocatalyst currently most widely used being titanium dioxide.

There are eleven crystalline structures for titanium dioxide, seven of which are stable at ambient temperature and pressure. In nature, titanium dioxide occurs mainly as anatase and rutile, and more rarely as brookite or TiO₂(B). Titanium dioxide is most often synthesized in the anatase form, or in the rutile form, and much more rarely in the brookite form. There are other forms which are more difficult to synthesize, such as various suboxides TiO₂₋ₓ and superoxides TiO₂₊ₓ.

The reference photocatalytic material in most laboratory studies is marketed by Evonik-Degussa under the name Aeroxide TiOP25 (formerly Degussa P25). This product consists of a mixture of approximately 80% anatase and 20% rutile for the crystallized phases and a small fraction of TiO in amorphous form. The exact structure of this Aeroxide product is discussed, see for example Jiang et al, Anatase and rutile in evonik aeroxide P25: heterojunctioned or individual nanoparticles?, Catalysis today, Vol 300, February 2018, pages 12-17. For a quantitative characterization of this Evonik Aeroxide P25 product, see for example the document Tobaldi et al, Fully quantitative X-ray characterization of Evonik Aeroxide TiO₂P25, Materials Letters, May 2014, Vol 122, 345-347.

Anatase has a bandgap energy of 3.23 eV. Anatase activity is thus limited to wavelengths shorter than the bandgap width, i.e. λ<387 nm. Rutile has a bandgap energy of 3.02 eV. Rutile activity is thus limited to wavelengths shorter than the bandgap width, i.e. λ<411 nm. These gap values can be slightly modulated according to the size of the material, by quantum confinement effects, or by doping with ions or metal nanoparticles.

In its most common commercial forms, TiO₂ is therefore mainly activated by ultraviolet light, with rutile also absorbing a small part of the visible spectrum. The useful wavelength ranges for rutile and anatase correspond to only about 6% of the solar radiation received on Earth, compared with about 50% for the visible range.

A great deal of work has been done to increase the effectiveness of titanium dioxide in visible light:
black titanium dioxide (Ullattil et al, Black TiO₂ nanomaterials: a review of recent advances, Chemical Engineering Journal 343, 2018, pages 708-736; Rajaraman et al, Black TiO₂: a review of its properties and conflicting trends, Chemical Engineering Journal Vol 389, 2020);
doped titanium dioxide (Kumaravel et al, Photocatalytic hydrogen production using metal doped TiO₂: a review of recent advances, Applied Catalysis B: Environmental vol 244, 2019, pages 1021-1064);
sensitized titanium dioxide, sensitized by heterojunction with a semiconductor, or by the plasmon effect, or by contact with a conjugated compound.

The invention relates in particular to the degradation of plastic materials by heterogeneous photocatalysis, the photocatalyst being in the solid phase and the reactants being in the gaseous or aqueous phase.

“Plastic material” refers to a synthetic material based on the use of macromolecules, which can be transformed especially by molding or forming.

Three main families of plastic materials are commercially available:
thermoplastics (in particular polyethylenes PE, polypropylenes PP, polystyrenes PS, polyvinyl chlorides PVC, polyamides PA, polyethylene terephthalates PET, polymethyl methacrylate PMMA, polycarbonates PC, polytetrafluoroethylene PTFE), thermosets (e.g. polyurethane), and elastomers.

Plastic materials are used in a wide range of industrial sectors, including packaging, construction, motor vehicles, agriculture, and textiles. Depending on how they are used, plastic materials contain functional additives such as plasticizers, flame retardants, and stabilizers. Plastic materials often contain fillers and pigments.

Environmental contamination by polymer materials is one of the most serious problems facing the world today.

According to a literature review by Ariza-Tarazona et al. (Microplastic pollution reduction by a carbon and nitrogen-doped TiO₂: Effect of pH and temperature in the photocatalytic degradation process, Journal of Hazardous Materials 395(2020 ) 122632), for the period from the 1950s to 2018, 6.3 billion metric tons of plastic waste were generated worldwide, with about 79% of this plastic waste ending up in the environment. Worldwide plastic production since the 1950s is set to cross the threshold of 12 billion metric tons by 2050.

Plastic waste is particularly found in the form of microplastics (MPs) and nanoplastics (NPs).

“Microplastics” refers to waste polymer materials in the form of debris between 1 micron and 5 mm in size (Frias et al, Microplastics: finding a consensus on the definition, Marine Pollution Bulletin, 2019). Microplastics result from the fragmentation of plastic waste or the emission of manufactured micrometric plastic products. A classification of plastic waste according to size and a classification of microplastics according to morphology are presented in Crawford et al, (Microplastic identification techniques. Microplastic Pollutants, 2017, 219-267).

Some authors use the term “nanoplastics” to refer to elements between 1 nm and 100 nm in size, while others use the term to refer to particles between 1 nm and 1000 nm in size (Hughes et al, Human and ecological health effects of nanoplastics: May not be a tiny problem, Current Opinion in Toxicology, volume 28, 2021).

Microplastics are ingested by marine organisms and enter the food chain (Danopoulos et al, Microplastic Contamination of Seafood Intended for Human Consumption: A Systematic Review and Meta-Analysis, Environmental Health Perspectives, 2020). The effects of microplastics and nanoplastics on human health are the subject of studies (Kumar et al, Micro(nano)plastics pollution and human health: How plastics can induce carcinogenesis to humans?, Chemosphere, volume 298, 2022; Hang et al, The ecotoxicological effects of microplastics on aquatic food web, from primary producer to human: A review, Ecotoxicology and Environmental Safety, volume 173, 2019).

As pointed out by Zhang et al, (Current technologies for plastic waste treatment: A review, Journal of Cleaner Production 2021, 282), a large number of techniques have been proposed in the prior art for the treatment of plastic waste, in particular reuse, incineration, landfill, pyrolysis, and various degradations (photodegradation, thermodegradation, biodegradation by invertebrates or microorganisms). Another presentation of these known techniques for treating plastic waste is provided by Ali et al., Degradation of conventional plastic wastes in the environment: a review on current status of knowledge and future perspectives of disposal, Science of The Total Environment, Volume 771, 2021.

Most of these techniques have drawbacks. It is not possible to return certain types of plastic waste to the status of products in circular economy channels, using the EoW (end-of-waste) procedure, or to reuse all types of plastic waste. Pyrolysis makes it possible to produce fuel by distillation, but generates residues. Incineration generates energy, but produces waste (flue gas treatment residues, bottom ash) and fumes. Landfilling may enable biogas to be recovered for energy purposes, but requires the leachate to be collected and treated, in order to protect the water table. Biodegradation of plastic materials by microorganisms or invertebrates is very slow (Shahnawaz et al, Bioremediation Technology for Plastic Waste, 2019). By way of example, document CN110507945 (Xiangrong, 2019) describes the use of Galleria mellonella for plastic degradation, with treatment lasting 400 days. Zhu et al (Journal of Cleaner Production, volume 310, 2021) report 35% degradation of polyurethane and 13% degradation of polystyrene by Galleria mellonella larvae after seven days.

Photodegradation seems to be the most promising answer to the treatment of plastic waste, especially when the energy source is sunlight.

It has been proposed to promote this photodegradation by using photodegradable plastics, see for example document WO2010/075609 (Goody Environment, 2010). The manufacture of this type of plastic is expensive, however, due to the use of additives to promote degradation. Controlling irradiation time is also tricky (Daglen et al. Photodegradable plastics: end-of life design principles, Green Chemistry Letters and Reviews. 3(2), 2010). Document EP2312959B1 (Rhodia, 2017) discloses a photodegradable plastic material having a cellulose ester content, and containing dispersed titanium dioxide, in particular anatase, the plastic being used for the manufacture of cigarette filters.

It has been proposed to integrate nanometric photocatalysts into polymer materials. The state of the art is presented by Nabi et al. Application of titanium dioxide for the photocatalytic degradation of macro and micro plastics: A review, Journal of Environmental Chemical Engineering, 9, 2021.

The document by Coburn et al. (Industrial scalable additives for enhanced decomposition of plastic waste through photocatalysis, Academic Journal of Polymer Science, 2020) describes the integration of the ZnO, WO₃ and Fe₂O₃, and TiO₂ (anatase) oxides in the form of nanoparticles, within four types of polymer films: polyethylene terephthalate (PET), high-density polyethylene (HDPE), low-density polyethylene (LDPE), and polystyrene (PS), which are then placed in salt water and photodegraded under ultraviolet light.

The document by Bandara et al. (Is nano ZrO₂ a better photocatalyst than nano TiO₂ for degradation of plastics, RSC advances, 2017, vol. 7, 83) describes the photocatalysis of polyethylene (PE) and polypropylene (PP) using nanoparticles of zirconium oxide ZrO₂ or titanium oxide TiO₂ (anatase), suspended in tetrahydrofuran, with treatment times ranging from 20 hours to 100 hours. Both materials were synthesized using a high-temperature treatment: 450° C. for TiO₂ and 700° C. for ZrO ₂. After 20 hours of irradiation under a solar simulator (1 h of solar simulator=10 h of sunlight), the reactivity of the ZrO₂ nanoparticles, with respect to the TiO₂ nanoparticles, was 7% and 20% higher for PE and PP, respectively.

The use of nanometric titanium oxide for the degradation of plastic materials is also proposed in the following documents: Lee et al, Water 2020, 12, 3551 (microfiber treatment with polyamide 66), Wang et al, Sol. Energy Mater. Sol. Cells 143, 2015 (treatment of high-density polyethylene), Ali et al, Environ. Nanotechnol. Monit. Manag. 5, 44-53 (treatment of low-density polyethylene films with TiO₂ nanotubes).

The following documents propose the photodegradation of plastic materials using doped titanium oxide: Nguyen et al, e-Polymers 2018 (benzophenone), Shang et al, Environ. Sci. Technol. 2003, 37, 4494-4499 (copper phthalocyanine), Li et al, Polym. Plast. Technol. Eng. 49, 400-406 (polypyrrole).

The use of doping agents has drawbacks. Some doping agents, e.g. benzophenone (CAS 119-61-9), are harmful to human health.

The modification of TiO₂ by doping adds an additional preparation step to the photocatalytic method, as well as a problem of stability with regard to the resulting composite material.

The use of photocatalysts in nanometric form entails risks of releasing nanoparticles into the environment.

Considering the potential health risks posed by titanium dioxide in its nanometric form, it has been proposed to fix the titanium dioxide to a support.

However, one of the major drawbacks of fixing the titanium dioxide to a support is greatly reduced photocatalytic activity with respect to dispersed TiO₂.

### INVENTION

The invention aims to overcome the drawbacks of known methods for degrading plastic materials.

A first subject of the invention is to provide a method for the photocatalytic degradation of plastic materials, enabling rapid degradation and production of recoverable carbon products.

A second subject of the invention is to provide a method for the photocatalytic degradation of plastic materials, enabling degradation under visible light without the use of organic solvents or high-temperature treatment.

A further subject of the invention is to provide a method that complies with at least one of the subjects hereinbefore, and enables the degradation of mixtures of plastic materials.

A further subject of the invention is to provide a method that complies with at least one of the subjects hereinbefore, and enables the degradation of plastic materials without prior treatment of these materials, only crushing optionally being carried out.

A further subject of the invention is to provide a method that complies with at least one of the subjects hereinbefore, and enables the degradation of microplastics.

A further subject of the invention is to provide a method that complies with at least one of the subjects hereinbefore, and enables the total degradation of plastic waste by photodegradation, and the recovery and use of the degradation products.

A further subject of the invention is to provide a method that complies with at least one of the subjects hereinbefore, and enables the degradation of plastic materials, without the risk of releasing nanoparticles into the environment.

A further subject of the invention is to provide a method that complies with at least one of the subjects hereinbefore, the method being integrated in-situ, all the steps of the method being able to be carried out on a single site.

For these purposes, according to a first aspect, a method for producing agglomerated and activated TiO₂ or TiO₂/MₓO_{y} to degrade a plastic material or a mixture of plastic materials is proposed, the method comprising the following sub-steps:
preparing and heating a surfactant-free aqueous solution at neutral pH or at a given acidic pH, e.g. by adding hydrochloric acid,
adding to the acidic or neutral aqueous solution a precursor of titanium oxide, or a mixture of a precursor of titanium oxide TiO₂ and at least one other precursor of another oxide MₓO_{y}, composed of more than 80 mol% of TiO₂ and less than 20 mol% of another metal or semi-metal oxide MₓO_{y}, and stirring the acidic or neutral aqueous reaction medium,
immersing a previously crushed plastic material or mixture of plastic materials in the acidic or neutral aqueous reaction medium,
heating the acidic or neutral aqueous reaction medium to a temperature of between 30° C. and 90° C., to condense the precursors of the acidic or neutral aqueous reaction medium on the surface of the plastic materials, the precursors attaching to this surface by covalent bonds, and forming the agglomerated and activated TiO₂/MₓO_{y},
photocatalytically degrading, at neutral or slightly acidic pH, the plastic material or the mixture of plastic materials, so as to obtain the agglomerated and activated TiO₂/MₓO_{y}, without the plastic material, that is suitable for degrading one or more other plastic materials.

In some implementations, a filtration step is carried out between the heating step and the photocatalytic degradation step, in order to remove the by-products formed during the crystallization of the TiO₂ or TiO₂/MₓO_{y}, this step making it possible to improve the kinetics of photocatalytic degradation of plastic materials.

The previously crushed plastic material or mixture of plastic materials allows the precursors of titanium oxide (or the mixture of the precursor of titanium oxide and at least one other precursor of the other metal or semi-metal oxide) to crystallize on the surface of the plastic materials, with the resulting TiO₂/MₓO_{y} being attached (grafted) to the surface of the plastic materials, by covalent bonds.

In some implementations, the pH is selected between 0 and 1, so as to obtain the agglomerated and activated TiO₂ from the TiO₂/MₓO_{y} on the one or more plastics, in rutile crystalline form.

In other implementations, the pH is selected between 5 and 7, so as to obtain the agglomerated and activated TiO₂ from the TiO₂/MₓO_{y} on the one or more plastics, in brookite crystalline form.

In some implementations, the method comprises a step of adding a titanium precursor carried out with the addition of a metal oxide WO₃, the pH of the reaction medium being between 0 and 7, so as to obtain the agglomerated and activated TiO₂ from the TiO₂/WO₃ on the one or more plastics, in anatase crystalline form.

Advantageously, the titanium precursor is selected from the group comprising titanium isopropoxide, sodium titanate Na₂Ti₃O₇ or a derivative thereof.

Advantageously, the metal or semi-metal oxide is selected from the group comprising SiO₂, ZrO₂, Al₂O₃, Fe₂O₃, CeO₂, MgO, CuO, NiO, Cu₂O, SnO₂, RuO₂, Bi2O₃, WO₃, V₂O₅, Ag₃PO₄.

According to a second aspect, an agglomerated and activated TiO₂/MₓO_{y} is proposed, to degrade a plastic material or a mixture of plastic materials, obtained by the method hereinbefore.

Advantageously, a TiO₂ or TiO₂/MₓO_{y} photocatalytic material is proposed, resulting from the method presented hereinbefore, this material is agglomerated and activated to degrade a plastic material or a mixture of plastic materials, using visible and/or UV light, in an acidic or neutral aqueous reaction medium at a temperature less than or equal to 90° C., composed of more than 80 mol% of TiO₂ and less than 20 mol% of another metal or semi-metal oxide MₓO_{y}, and wherein the agglomerated TiO₂ or TiO₂/MₓO_{y} is activated after photocatalytically degrading a first plastic material or a mixture of plastic materials, according to the method presented hereinbefore.

In some implementations, the agglomerated TiO₂ or TiO₂/MₓO_{y} has agglomerates of 300 nm to 5 microns, advantageously 300 nm to 1 micron,

Advantageously, the agglomerated TiO₂ or TiO₂/MₓO_{y} photocatalytic material has spectroscopically visible traces of the first plastic material or of the mixture of plastic materials.

In some implementations, the agglomerated TiO₂ or TiO₂/MₓO_{y} photocatalytic material is agglomerated TiO₂ only, with spectroscopically visible traces of the first plastic material or of the mixture of plastic materials.

In some implementations, the agglomerated TiO₂ or TiO₂/MₓO_{y} photocatalytic material is agglomerated TiO₂/MₓO_{y} only, with spectroscopically visible traces of the first plastic material or of the mixture of plastic materials.

Advantageously, for the agglomerated TIO₂ or TiO₂/MₓO_{y} photocatalytic material, the agglomerated and activated TiO₂ or TiO₂/MₓO_{y} is obtained without calcination.

In some implementations, in the agglomerated TiO₂ or TiO₂/MₓO_{y} photocatalytic material, the TiO₂ of the agglomerated TiO₂ alone or of the agglomerated TiO₂/MₓO_{y} has a rutile crystalline form.

In other implementations, for the agglomerated TiO₂ or TiO₂/MₓO_{y} photocatalytic material, the TiO₂ of the agglomerated TiO₂ alone or of the agglomerated TiO₂/MₓO_{y} has a brookite crystalline form.

According to a third aspect, a method for degrading a second plastic material or a mixture of plastic materials is proposed, using an agglomerated and activated TiO₂ or TiO₂/MₓO_{y} photocatalytic material, and having already degraded a first plastic material or a mixture of plastic materials, the degradation method comprising, in a first cycle:
a step 1) of suspending the agglomerated and activated TiO₂ or TiO₂/MₓO_{y} having degraded a first plastic material or mixture of plastic materials, by stirring, advantageously at a pH between 5 and 7;
a step 2) of adding one or more previously crushed second plastic materials to the solution;
a step 3) of heating the solution, advantageously between 70° C. and 90° C., to graft the agglomerated and activated TIO₂ or TiO₂/MₓO_{y}, in suspension by stirring, onto the second plastic material or mixture of plastic materials;
a step 4) of photocatalytically degrading the second plastic material or mixture of plastic materials grafted with the agglomerated and activated TiO₂ or TiO₂/MₓO_{y}, at least in the visible range, forming decomposition products.

Advantageously, the degradation method comprises one or more repetitions of steps 2) to 4), each repetition of these steps 2) to 4) corresponding to one cycle, using the same agglomerated and activated TiO₂/MₓO_{y}.

Advantageously, the photocatalytic degradation step is carried out in natural light or under visible radiation.

In some implementations, the photocatalytic degradation step is carried out by placing the material in contact with atmospheric oxygen, at atmospheric pressure.

In some implementations, the decomposition products are of the carboxylic acid or alcohol type.

Advantageously, the decomposition products are selected from the following list: acetone, acetic acid, formic acid, isopropanol, methanol, methyl formate, methyl acetate, glycerol, glyoxal, ethanol.

Advantageously, the decomposition products comprise biogases such as hydrogen, methane, CO, and/or CO₂.

In some implementations, the suspension is carried out, in step 4), using a peristaltic pump or a compressed air flow.

In some implementations, step 4) of degrading the plastic material or the plastic materials grafted with the agglomerated and activated TiO₂ or TiO₂/MₓO_{y} in suspension by stirring is carried out in the solution.

In some implementations, the acidic or neutral aqueous solution in which the plastic material or mixture of plastic materials is degraded is only water, such as tap water.

In some implementations, in step 1) a mixture of crystalline forms of agglomerated TiO₂ alone or agglomerated TiO₂/MₓO_{y} is added, which comprises the rutile form and the brookite crystal form.

In some implementations, the method comprises a step 3) of heating the solution to between 30° C. and 90° C., advantageously to 90° C., and a step 4) of degrading the second plastic material or the mixture of plastic materials grafted with the agglomerated and activated TiO₂ or TiO₂/MₓO_{y}, at a temperature of between 30° C. and 90° C.

Further subjects and advantages of the invention will become apparent from the description of some embodiments, which is provided hereinafter with reference to the accompanying drawings, wherein:

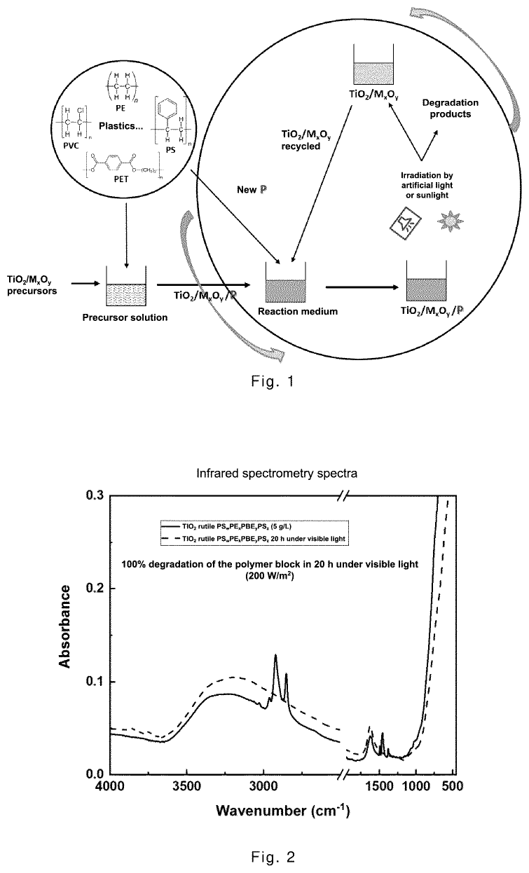

FIG. 1 is a diagram depicting the production of agglomerated and activated titanium oxide TiO₂, and the method for degrading plastic materials with this titanium oxide;

FIG. 2 shows infrared spectra, for wavelengths (wavenumber) between 500 and 4000cm⁻¹ , for a mixture of plastic materials comprising polystyrene PS, polyethylene PE, and polybutylene PBE, at a concentration of 5 g/L, in the initial state (solid line curve) and after treatment by photocatalysis for 20 h (dashed line curve), the photocatalysis being carried out under visible light, the titanium oxide used being in rutile form;

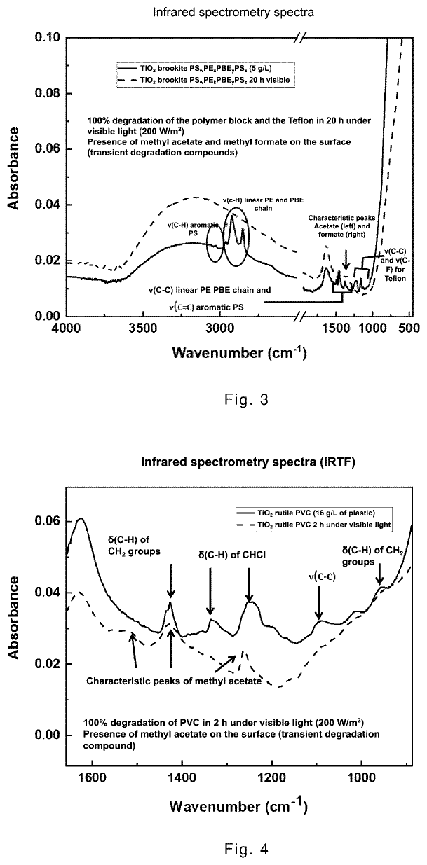

FIG. 3 shows infrared spectra, for wavelengths between 500 and 4000cm⁻¹, for a mixture of plastic materials comprising polystyrene PS, polyethylene PE, and polybutylene PBE, at a concentration of 5 g/L, in the initial state (solid line curve) and after treatment by photocatalysis for 20 h (dashed line curve), under visible light, the titanium oxide used being in brookite form;

FIG. 4 shows infrared spectra, for wavelengths between about 1000 and 1600cm⁻¹, for a mixture of polyvinyl chloride, at a concentration of 16 g/L, in the initial state (solid line curve) and after treatment by photocatalysis for 2 h (dashed line curve), under visible light, the titanium oxide used being in rutile form;

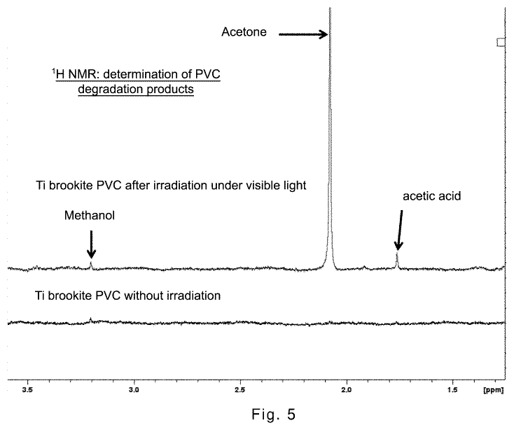

FIG. 5 is a partial view of a ¹H NMR spectrum showing the products of PVC degradation by titanium oxide, according to a method as shown in FIG. 1, the photodegradation being carried out under visible light, the titanium oxide being in brookite form.

Firstly, a method for producing an agglomerated and activated TiO₂/MₓO_{y} material for degrading plastic materials is described.

The method comprises preparing and heating a surfactant-free aqueous solution at neutral pH, or at acidic pH, for example by adding hydrochloric acid.

The method then comprises a step of adding to the acidic or neutral aqueous solution a precursor of titanium oxide (or a mixture of a precursor of titanium oxide TiO₂ and at least one other precursor of another oxide MₓO_{y}, composed of more than 80 mol % of TiO₂ and less than 20 mol % of another metal or semi-metal oxide MₓO_{y}), with stirring of the acidic or neutral aqueous reaction medium.

The method then comprises a step of immersing a previously crushed plastic material or mixture of plastic materials in the acidic or neutral aqueous reaction medium to condense the precursors of the acidic or neutral aqueous reaction medium on the surface of the plastic materials, with the resulting agglomerated and activated TiO₂/MₓO_{y} attaching (grafting) to this surface by covalent bonds.

The plastic material or mixture of plastic materials is advantageously crushed in order to obtain a maximum grain size of a few millimeters.

The method then comprises heating the acidic or neutral aqueous reaction medium, advantageously to a temperature of between 30° C. and 90° C.

The previously crushed plastic material or mixture of plastic materials is used to crystallize the TiO₂/MₓO_{y} material from the precursors of titanium oxide (or from the mixture of the precursor of titanium oxide and at least one other precursor of the other metal or semi-metal oxide) on the surface of the plastic materials, the agglomerated and activated TiO₂/MₓO_{y} material being attached (grafted) to the surface of the plastic materials by covalent bonds.

Advantageously, a filtration step is carried out to remove the by-products formed during crystallization, this step improving the kinetics of the photocatalytic degradation of the plastic materials.

The method then comprises a step of photocatalytically degrading, in slightly acidic or neutral pH medium, the plastic material or mixture of plastic materials grafted on the agglomerated and activated TiO₂/MₓO_{y}.

This degradation of plastic materials using the agglomerated and activated TiO₂/MₓO_{y} is disclosed next.

The method takes place in a suitable reactor in an optionally acidified aqueous solution. The pH range is between 0 and 7. Tap water can be used, as can rainwater.

The precursor of titanium (e.g. 97% titanium isopropoxide) or a mixture of a precursor of titanium and another oxide (e.g. aluminum oxide, iron oxide or tungsten oxide) is then incorporated at a temperature of 50° C. and under vigorous stirring (600 rpm).

Once the precipitate that forms instantly has completely dissolved, 300 mg to 1300 mg of previously crushed plastic material (or mixture of plastic materials) is added.

The plastic materials are, for example, a polystyrene, a polyethylene, a polyvinyl chloride, a polypropylene, a polyurethane, a polymethyl methacrylate, and a perfluorinated polymer.

The stirring is then moderated when a new precipitate appears (approx. 300 rpm). The temperature is maintained at 50° C. for at least 5 hours (ideally 24 h), and then raised to 90° C. for 19 hours (ideally 24 h).

The resulting composite materials are micrometric or millimetric in size.

The reaction medium is then placed in a new chamber and irradiated, advantageously with visible radiation, to degrade the one or more plastic materials.

In some embodiments, a filtration step is carried out prior to the photocatalytic degradation of the plastic materials in order to remove the by-products formed during the crystallization of the TiO₂/MₓO_{y}, this step making it possible to improve the kinetics of the photocatalytic degradation of the plastic materials.

The particles in solution are advantageously placed in suspension, for example by passing compressed air or by a fluidic pump for better contact with the light.

Once the plastic material (or the mixture of plastic materials) has been degraded, the agglomerated and activated TiO₂/MₓO_{y} is directed towards the synthesis reactor, to resupply with plastic material from 300 mg to 1300 mg for the recycling cycle

In the synthesis reactor, the neutral or weakly acidic reaction medium (range 5-7) is placed in suspension by stirring and heated to 90° C. for up to 24 hours.

The TiO₂/MₓO_{y}/plastic material (or TiO₂/MₓO_{y}/mixture of plastic materials) re-introduced into the photocatalysis chamber is suspended by stirring in solution and then irradiated. Once the new plastic material (or new mixture of plastic materials) has been degraded, a new cycle of recycling and degradation can be carried out, and so on.

The invention has numerous advantages.

The resulting agglomerated and activated TiO₂/MₓO_{y} has a long service life, and enables multiple recycling and degradation cycles.

The TiO₂/MₓO_{y}/plastic material (or TiO₂/MₓO_{y}/mixture of plastic materials) composite materials are also active in the open air, without the presence of water. Thus, after the synthesis or the recycling cycles, the composite materials can be filtered and dried, and the powder can be irradiated with visible radiation in the open air.

The method enables the degradation of plastic materials that are currently not recyclable or poorly recyclable or reusable (PVC, low-density PE, PMMA, PU, PS, perfluorinated polymers such as polytetrafluoroethylene PTFE), as well as of mixtures of these polymers.

The method enables the recovery of degradation products, in particular the organic products (methanol, acetone, isopropanol, acetic acid, gas).

The method makes it possible to eliminate microplastics, for example from the seas and oceans.

Advantageously, the method enables photodegradation using energy-efficient LED light sources or sunlight.

The method avoids the risk of dispersing nanoparticles in the environment, as the particles of titanium oxides or of an agglomerated and activated mixture of titanium oxide and another oxide are recycled in a closed environment.

Advantageously, once bonded to the surface of a plastic material or of a mixture of plastic materials, the particles of agglomerated and activated TiO₂/MₓO_{y} are micrometric in size, and remain larger than the nanometric threshold which is dangerous for the environment (Decree no. 2012-232 of Feb. 17, 2012 relating to the annual declaration of substances in nanoparticulate form, taken in application of Article L. 523-4 of the Environmental Code), even after degradation of the plastic material that served as their support.

The resulting photoactive composite materials are at least micrometric in scale.

The method makes it possible to produce alcohols, carboxylic acids, ketones and biogas.

The method makes it possible to eliminate a plastic material (or mixtures of plastic materials) in very short times, with irradiation of around 2 hours to 24 hours.

The method uses titanium oxide in a pure rutile phase or a pure brookite phase.

1. A method for producing agglomerated and activated TiO₂ or TiO₂/MₓO_{y} to degrade a plastic material or a mixture of plastic materials, which method comprises the steps of:
preparing and heating a surfactant-free aqueous solution at neutral pH or at a given acidic pH,
adding to the acidic or neutral aqueous solution a precursor of titanium oxide, or a mixture of a precursor of titanium oxide TiO₂ and at least one other precursor of another oxide MₓO_{y}, composed of more than 80 mol % of TiO₂ and less than 20 mol % of another metal or semi-metal oxide MₓO_{y}, and stirring the acidic or neutral aqueous reaction medium,
immersing a previously crushed plastic material or mixture of plastic materials in the acidic or neutral aqueous reaction medium,
heating the acidic or neutral aqueous reaction medium to a temperature of between 30° C. and 90° C.,
to condense the precursors of the acidic or neutral aqueous reaction medium on the surface of the one or more plastic materials, the precursors attaching to this surface by covalent bonds and forming the agglomerated and activated TiO₂/MₓO_{y},
photocatalytically degrading, at neutral or acidic pH, the plastic material or the mixture of plastic materials, so as to obtain the agglomerated and activated TiO₂/MₓO_{y}, without the plastic material, that is suitable for degrading one or more other plastic materials.

2. The method according to claim 1, wherein a filtration step is carried out between the heating step and the photocatalytic degradation step, in order to remove the by-products formed during the crystallization of the TiO₂ or TiO₂/MₓO_{y}, this step making it possible to improve the kinetics of the photocatalytic degradation of the plastic materials.

3. The method according to claim 1, wherein the pH is selected between 0 and 1, so as to obtain the agglomerated and activated TiO₂ from the TiO₂/MₓO_{y} on the one or more plastic materials, with a rutile crystalline form.

4. The method according to claim 1, wherein the pH is selected between 5 and 7, so as to obtain the agglomerated and activated TiO₂ from the TiO₂/MₓO_{y} on the one or more plastic materials in brookite form.

5. The method according to claim 1, wherein the step of adding a titanium precursor is carried out with the addition of a metal oxide WO₃, the pH of the reaction medium being between 0 and 7, so as to obtain the TiO₂ from the agglomerated and activated TiO₂/WO₃ on the one or more plastic materials, with an anatase crystalline form.

6. The method according to claim 1, wherein the titanium precursor is selected from the group comprising titanium isopropoxide, sodium titanate Na₂Ti₃O₇ or a derivative thereof.

7. The method according to claim 1, wherein the metal or semi-metal oxide is selected from the group comprising SiO₂, ZrO₂, Al₂O3, Fe₂O3, CeO₂, MgO, CuO, NiO, Cu₂O, SnO₂, RuO₂, Bi₂O₃, WO₃, V₂O₅, Ag₃PO₄.

8. A TiO₂ or TiO₂/MₓO_{y} photocatalytic material, produced by the method according to claim 1, which material is agglomerated and activated to degrade a second plastic material or a mixture of plastic materials on which it is agglomerated, using visible and/or UV light, in an acidic or neutral aqueous reaction medium at a temperature of 90° C. or less, composed of more than 80 mol % of TiO₂ and less than 20 mol % of another metal or semi-metal oxide MₓO_{y}, and wherein the agglomerated TiO₂ or TiO₂/MₓO_{y} is activated after photocatalytically degrading a first plastic material or a mixture of plastic materials, wherein the agglomerated TiO₂ or TiO₂/MₓO_{y} has agglomerates of 300 nm to 5 microns, advantageously 300 nm to 1 micron, wherein the photocatalytic material has spectroscopically visible traces of the first plastic material or of the mixture of plastic material.

9. The agglomerated TiO₂ or TiO₂/MₓO_{y} photocatalytic material according to claim 8, wherein the material is agglomerated TiO₂ only, with spectroscopically visible traces of the first plastic material or of the mixture of plastic materials.

10. The agglomerated TiO₂ or TiO₂/MₓO_{y} photocatalytic material according to claim 8, wherein the material is agglomerated TiO₂/MₓO_{y} only, with spectroscopically visible traces of the first plastic material or of the mixture of plastic materials.

11. The agglomerated TiO₂ or TiO₂/MₓO_{y} photocatalytic material according to claim 8, wherein the agglomerated and activated TiO₂ or TiO₂/MₓO_{y} is obtained without calcination.

12. The agglomerated TiO₂ or TiO₂/MₓO_{y} photocatalytic material according to claim 8, wherein the TiO₂ of the agglomerated TiO₂ alone or of the agglomerated TiO₂/MₓO_{y} has a rutile crystalline form or a brookite crystalline form.

13. (canceled)

14. A method for degrading a second plastic material or a mixture of plastic materials, using an agglomerated and activated TiO₂ or TiO₂/MₓO_{y} photocatalytic material according to claim 8, which has already degraded a first plastic material or mixture of plastic materials,
the degradation method comprising in a first cycle:
a step 1) of suspending the agglomerated and activated TiO₂ or TiO₂/MₓO_{y} having degraded a first plastic or mixture of plastic materials, by stirring, advantageously at a pH between 5 and 7;
a step 2) of adding one or more previously crushed second plastic materials to the solution;
a step 3) of heating the solution, advantageously between 70° C. and 90° C., to graft the agglomerated and activated TiO₂ or TiO₂/MₓO_{y}, in suspension by stirring, onto the second plastic material or mixture of plastic materials;
a step 4) of photocatalytically degrading the second plastic material or mixture of plastic materials grafted with the agglomerated and activated TiO₂ or TiO₂/MₓO_{y}, at least under visible light, forming decomposition products.

15. The method according to claim 14, wherein the method comprises one or more repetitions of steps 2) to 4), each repetition of these steps 2) to 4) corresponding to one cycle, using the same agglomerated and activated TiO₂ or TiO₂/MₓO_{y}.

16. The degradation method according to claim 14, wherein the photocatalytic degradation step is carried out in natural light or under visible radiation.

17. The degradation method according to claim 14, wherein the photocatalytic degradation step is carried out by being placed in contact with atmospheric oxygen at atmospheric pressure.

18. The degradation method according to claim 14, wherein the decomposition products are of the carboxylic acid or alcohol type or comprise biogases such as hydrogen, methane, CO, and/or CO₂.

19-20. (canceled)

21. The degradation method according to claim 14, wherein the acidic or neutral aqueous solution in which the plastic or the mixture of plastic materials is degraded is only water, such as tap water.

22-24. (canceled)

25. The degradation method according to claim 14, comprising:
a step 3) of heating the solution, between 30° C. and 90° C., advantageously to 90° C.;
a step 4) of degrading the second plastic material or the plastic materials grafted with the agglomerated and activated TiO₂ or TiO ₂/MₓO_{y}, at a temperature of between 30° C. and 90° C.
